(19) United States
(12) Patent Application Publication
(10) Pub. No.: US 2002/0142654 A1
(43) Pub. Date: Oct. 3, 2002

(54) Connector plug gap sealer

(76) Inventors: Dennis P. Bobay, Ossian, IN (US); Robert K. Hollenbeck, Fort Wayne, IN (US); James Grimm, Fort Wayne, IN (US); Norman C. Golm JR., Fort Wayne, IN (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 09/681,384

(22) Filed: Mar. 27, 2001

(51) Int. Cl. H01R 13/40

(52) U.S. Cl. 439/587

(57) ABSTRACT

A connector plug gap sealer that fits smoothly within an internal cavity of a connector plug includes a first section, a second section, and a third section, the second section includes a flat section and a guiding section, the third section extending from the guiding section around the horizontal axis of symmetry. The first, second and the third sections configured into a single unitary piece to define the plug gap sealer having a flat bottom surface around the horizontal axis of symmetry of the plug gap sealer. The method associated with installing the connector plug gap sealer is also disclosed.

### BACKGROUND OF INVENTION

This invention relates generally to electric motors and, more particularly, to connector plug gap sealer used within electric motors.

Many times a designer is forced to use catalog components when selecting plug connectors. It is not uncommon for the plug to have more terminal cavities available than what are actually being used. When the cavities are not used, there are holes or cavities in or around the connector that are potential paths for molten metal, water, other liquids depending on the motor application, and or electrical sparks to pass through. This potential obstacle is a serious problem in acquiring agency approvals.

Therefore, it would be desirable to have a connector plug gap sealer capable of sealing the unused terminal cavities and other gaps.

### SUMMARY OF INVENTION

In an exemplary embodiment, a connector plug gap sealer includes a body and a leg attached to the body. The plug gap sealer is inserted into a gap of a connector to fill a cavity. The plug gap sealer snap-fits into the connector gap without using additional hardware and engages the connector by positively latching the connector. The plug sealer device is axially positioned when it is fully seated in the connector cavity.

A connector plug gap sealer fits smoothly within an internal cavity of a connector plug. The connector plug gap sealer includes a first section, a second section, and a third section. The second section includes a flat section and a guiding section extends from the first section around a horizontal axis of symmetry and a third section. The third section extends from the guiding section around the horizontal axis of symmetry. The first, second and the third sections form a unitary gap sealer having a flat bottom surface around the horizontal axis of symmetry of the plug gap sealer.

A method for installing a connector plug gap sealer includes positioning a plug gap sealer, inserting the plug gap sealer into a cavity of a connector plug, and applying sufficient pressure to lock a guiding section of the plug gap sealer into a secured position within the cavity of the connector plug.

### BRIEF DESCRIPTION OF DRAWINGS

FIG. 1 is a perspective view of a connector plug gap sealer.

FIG. 2 is a side view of the connector plug gap sealer shown in FIG. 1.

FIG. 3 is an exemplary embodiment of method steps showing the connector plug gap sealer installation.

FIG. 4 is a perspective view of an alternative embodiment of a connector plug gap sealer to seal two adjacent cavities of a connector plug.

FIG. 5 is a side elevational view of alternative embodiment of the connector plug gap sealer.

FIG. 6 is an expanded portion of a second section and a third section of the alternative embodiment of the connector plug gap sealer.

FIG. 7 is a backside elevational view of the alternative embodiment of the connector plug gap sealer.

FIG. 8 is an expanded portion of a second section and a third section of the alternative embodiment of the connector plug gap sealer.

FIG. 9 is an end view of the connector plug gap sealer shown in FIG. 4.

FIG. 10 is an exemplary embodiment of method steps showing installation of the connector plug gap sealer shown in FIG. 4.

### DETAILED DESCRIPTION

While the present invention is susceptible of embodiments in various forms, it is described in some selected exemplary embodiments with the understanding that the present disclosure is to be considered an exemplification of the invention and is not intended to limit the invention to the specific embodiments illustrated. It will be recognized by those skilled in the art that although, the present plug gap sealer design is related to a particular connector, the plug gap sealer can be modified to fit other suppliers' connectors.

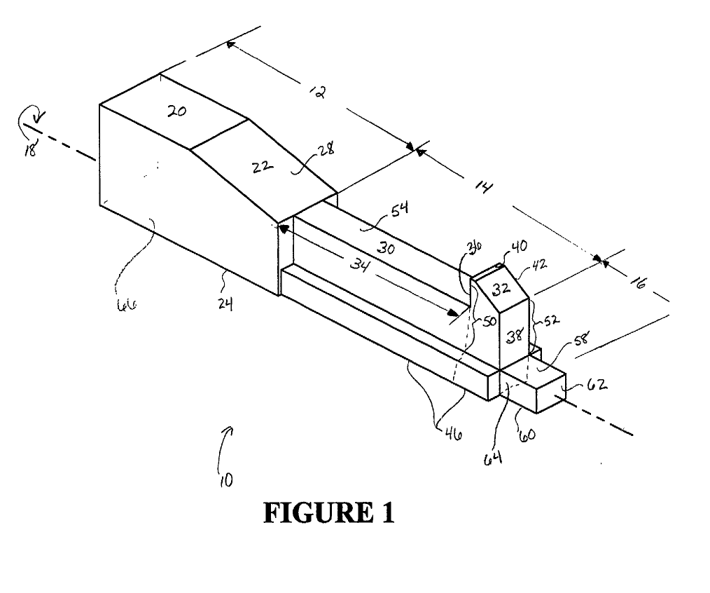

FIG. 1 is a perspective view of a connector plug gap sealer 10 including three sections 12, 14, and 16. Plug gap sealer 10 has an axis of symmetry 18. Sections 12, 14, and 16 are molded to form a single piece around axis of symmetry 18. In an alternative embodiment, the three sections are fabricated from a flexible, yet firm plastic material, and then assembled together to form a single housing 10.

First section 12 includes an upper body 20 and a lower body 22. Lower body 22 has a trapezoid shape having a first flat bottom surface 24 and a sloped top surface 28. Upper body 20 is rectangular in shape and connected to lower body 22 around axis of symmetry 18. In an alternative embodiment, upper body 20 is square in shape and connected to lower body 22 around axis of symmetry 18.

Second section 14 extends from first section 12 around axis of symmetry 18 and includes a flat section 30 and a guiding section 32. Flat section 30 is rectangular in shape having a length 34 equal to a flat portion of an internal cavity of a connector (not shown). Guiding section 32 includes two substantially parallel surfaces 36 and 38 perpendicular to axis of symmetry 18 and a substantially flat surface 40 connected to a sloped surface 42. Flat surface 40 is substantially parallel to a second flat bottom surface 46. Guiding section top surface 40 has a beveled angle where first end height 50 is greater than second end height 52. Bottom surface 46 is also substantially parallel to an upper surface 54 of flat section 30 and extends all the way to form the bottom surface of second section 14. Bottom surface 24 of first section 12 is substantially planar with bottom surface 46 of second section 14.

Third section 16 is rectangular in shape with an upper surface 58, a bottom surface 60, and two substantially parallel surfaces 62 and 64. Bottom surface 60 is substantially parallel to upper surface 58 of third section 16 and extends all the way to form the bottom surface 66 of plug sealer 10. Bottom surface 24 of first section 12 is substantially planar with bottom surface 46 of second section 14 and bottom surface 60 of third section 16 to form a unitary bottom surface 66 of plug sealer 10.

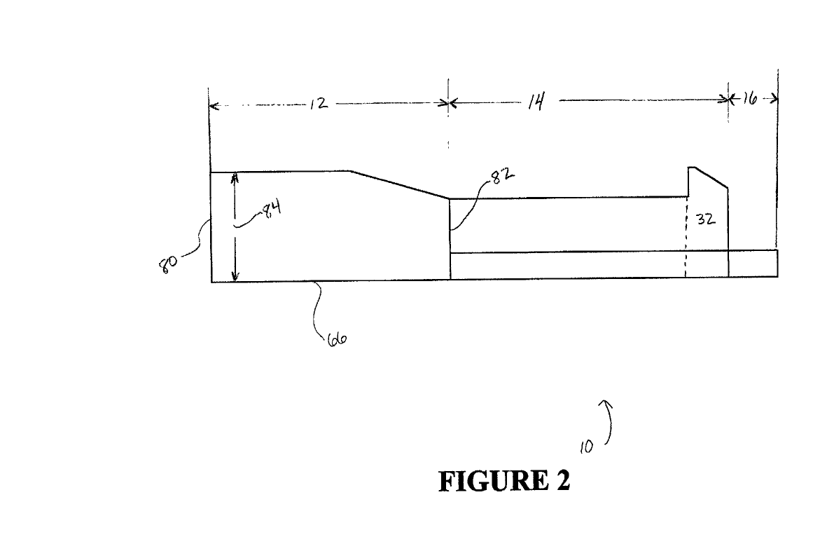

FIG. 2 is a side view of connector plug gap sealer 10 shown in FIG. 1. Plug gap sealer 10 includes three sections 12, 14, and 16. Plug gap sealer 10 has an axis of symmetry 18 (shown in FIG. 1). Connector plug gap sealer 10 further includes two substantially parallel surfaces 80 and 82 of first section 12. A height 84 of parallel surface 80 is sufficient to fit in snuggly into the cavity of the connector. Parallel surfaces 80 and 82 are perpendicular to unitary bottom surface 66 of plug gap sealer 10 and perpendicular to axis of symmetry 18. Guiding section 32 helps guide plug gap sealer 10 into a position within the connector cavity (not shown).

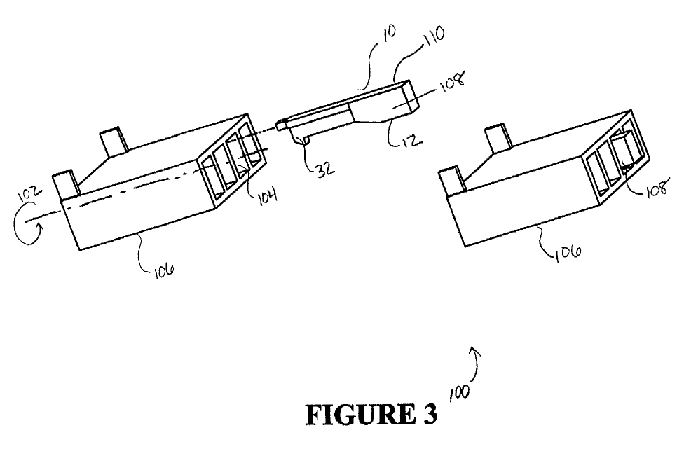

FIG. 3 is an exemplary embodiment of method 100 steps showing connector plug gap sealer 10 installation. Method 100 includes holding plug sealer 10 from first section 12 and aligning plug gap sealer 10 such that axis of symmetry 18 of plug sealer 10 is substantially collinear to an axis of symmetry 102 of cavity 104 of connector plug 106. Once aligned, the method further includes inserting plug sealer 10 into cavity 102 and applying sufficient pressure on side walls 108 and 110 to lock guiding section 32 (shown in FIG. 1) of plug sealer 10 into a secured position within cavity 102 of connector plug 106.

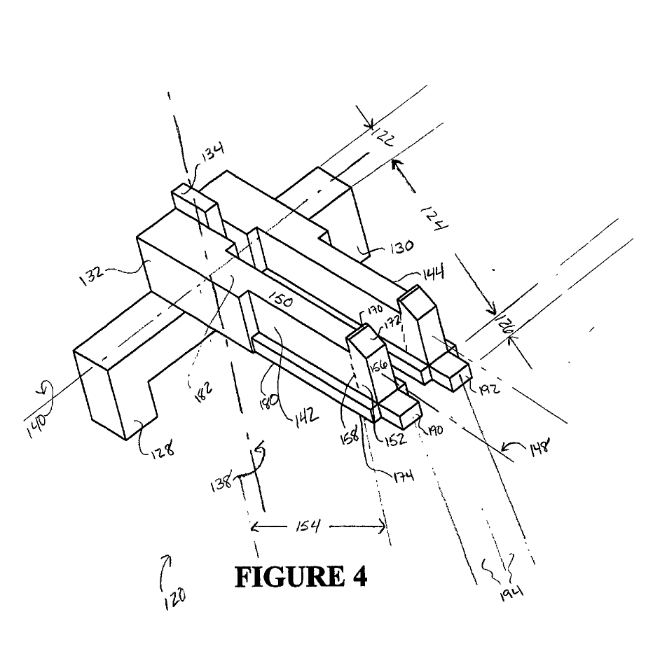

FIG. 4 is a perspective view of an alternative embodiment of a connector plug gap sealer 120 having dual axial positioning arms to seal two adjacent cavities of a connector plug. Plug gap sealer device 120 includes three separate sections 122, 124, and 126. First section 122 is a base section comprising a first handle 128 and a second handle 130 connected by a middle upper body 132. An upper body 134 is connected to middle upper body 132. First section 122 also includes a vertical axis of symmetry 138 and a horizontal axis of symmetry 140.

Second section 124 includes a first leg 142 and a second leg 144. First leg 142 and second leg 144 are positioned equidistant from vertical axis of symmetry 138. Structural configurations of first leg 142 and second leg 144 are identical.

First leg 142 extends from first section 144 around a horizontal axis of symmetry 148 of second section 124. Horizontal axis of symmetry 148 is substantially perpendicular to vertical axis of symmetry 138 of the first section. Second section 124 includes a flat section 150 and a guiding section 152. Flat section 150 is rectangular in shape having a length 154 equal to a flat portion of an internal cavity of a connector (not shown). Guiding section 152 includes two substantially parallel surfaces 156, 158 and are perpendicular to axis of symmetry 148.

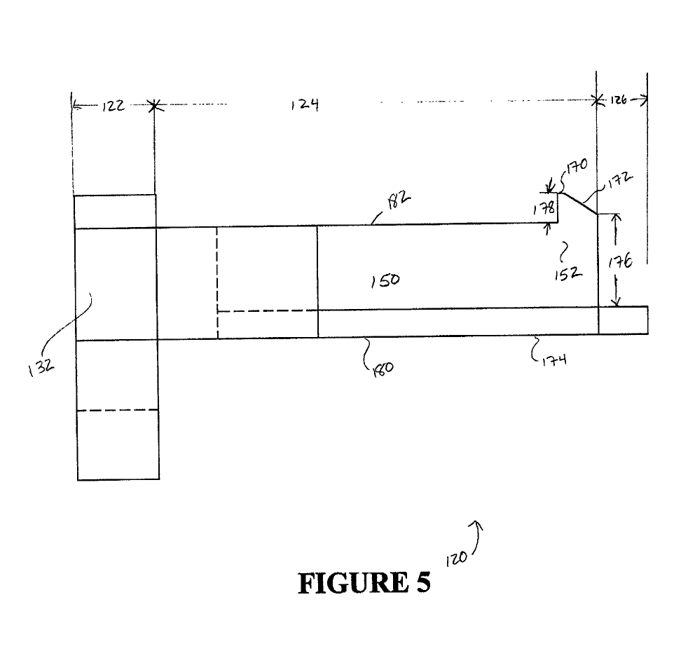

FIG. 5 is a side elevational view of an alternative embodiment of a connector plug gap sealer 120. A substantially flat top surface 170 is connected to a sloped surface 172. Flat surface 170 is substantially parallel to a flat bottom surface 174. Top surface 170 of guiding section 152 has a beveled angle where first end height 176 is greater than second end height 178. Bottom surface 180 is also substantially parallel to an upper surface 182 of flat section 150 and extends all the way form the middle upper body 132 of first section 122.

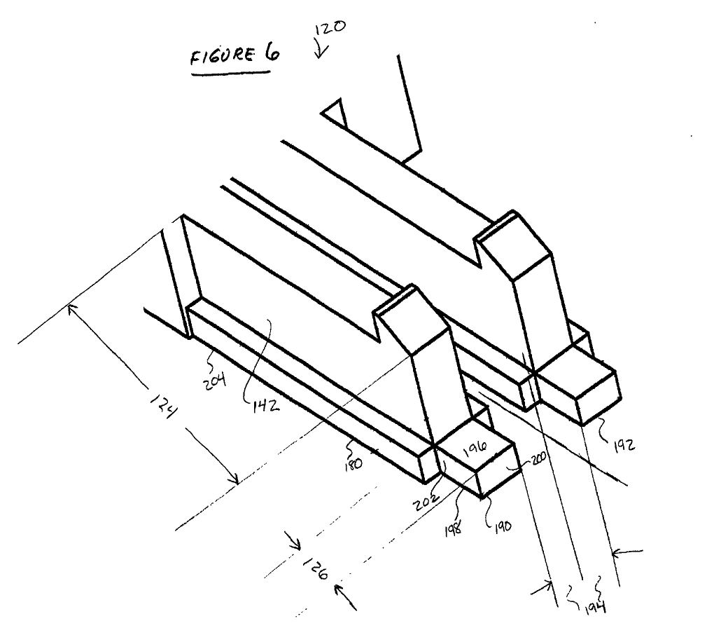

FIG. 6 is an expanded portion of second section 124 and third section 126 of alternative embodiment of a connector plug gap sealer 120. Third section 126 includes a first end 190 and a second end 192. First end 190 and second end 192 are positioned equidistant from vertical axis of symmetry 138 (shown in FIG. 4) and away from vertical axis by a pre-determined distance 194. Distance 194 is computed based on the length of an internal cavity of a connector (not shown). Structural configurations of first end 190 and second end 192 are substantially identical.

First leg 142 is connected to first end 190 to a first axial positioning arm. First end 190 is rectangular in shape with an upper surface 196, a bottom surface 198, and two substantially parallel surfaces 200 and 202. Bottom surface 198 is substantially parallel to upper surface 196 and extends all the way to form a bottom surface 204 of plug sealer 120. Bottom surface 180 of first leg 142 and bottom surface 198 of first end 190 are substantially planar to form a unitary bottom surface 204 connecting the first leg and the first end of plug sealer 120.

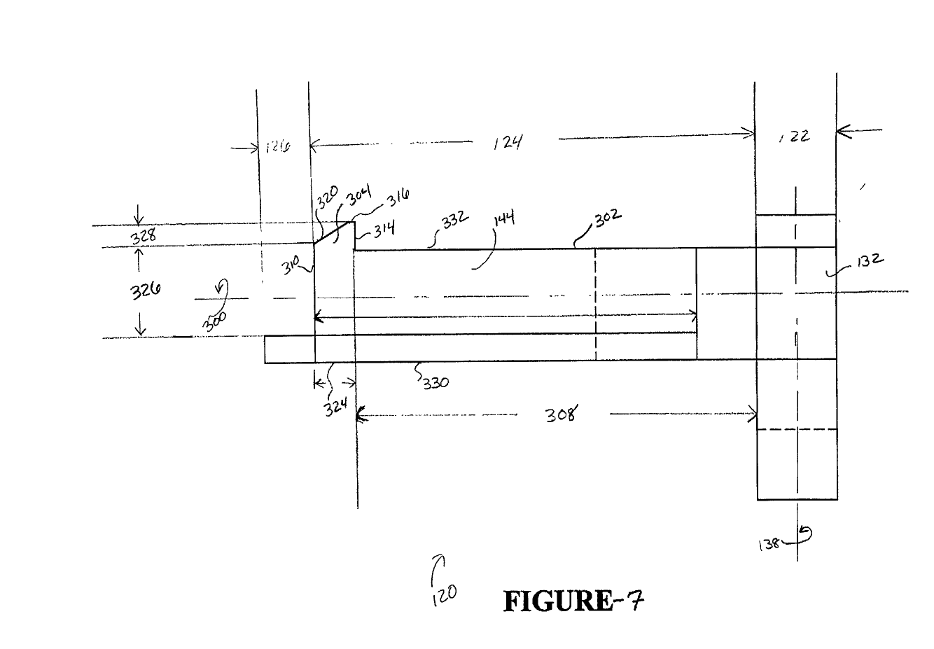

FIG. 7 is a backside elevational view of alternative embodiment of a connector plug gap sealer 120. Second leg 144 extends from first section 122 around a horizontal axis of symmetry 300 of second section 124. Horizontal axis of symmetry 300 is substantially perpendicular to axis of symmetry 138 of first section 1220. Second section 124 includes a flat section 302 and a guiding section 304. Flat section 302 is rectangular in shape having a length 308 equal to a flat portion of an internal cavity of a connector (not shown). Guiding section 304 includes two substantially parallel surfaces 310, 314 and perpendicular to horizontal axis of symmetry 300. A substantially flat top surface 316 is connected to a sloped surface 320. Flat surface 316 is substantially parallel to a flat bottom surface 324. Top surface 316 of guiding section 304 has a beveled angle where first end height 326 is greater than second end height 328. Bottom surface 330 is also substantially parallel to an upper surface 332 of flat section 302 and extends all the way form the middle upper body 132 of first section 122. Horizontal axis of symmetry 148 (shown in FIG. 4) and horizontal axis of symmetry 300 are equidistant from vertical axis of symmetry 138.

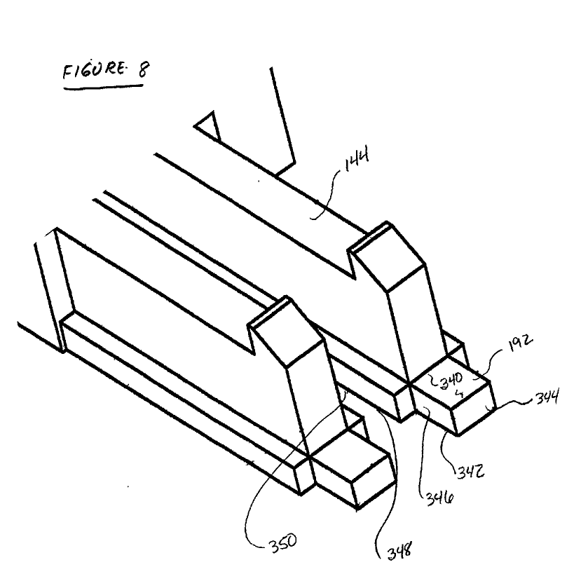

FIG. 8 is an expanded portion of second section 124 and third section 126 of an alternative embodiment of a connector plug gap sealer 120. Second leg 144 is connected to second end 192 to form a second axial positioning arm. Second end 192 is rectangular in shape with an upper surface 340, a bottom surface 342, and two substantially parallel surfaces 344 and 346. Bottom surface 342 is substantially parallel to upper surface 340 of second end 192 and extends all the way to form a bottom surface 348 of plug sealer 120. Bottom surface 330 (shown in FIG. 7) of second leg 144 and bottom surface 342 of second end 192 are substantially planar to form a unitary bottom surface 350 connecting the second leg and second end of plug sealer 120.

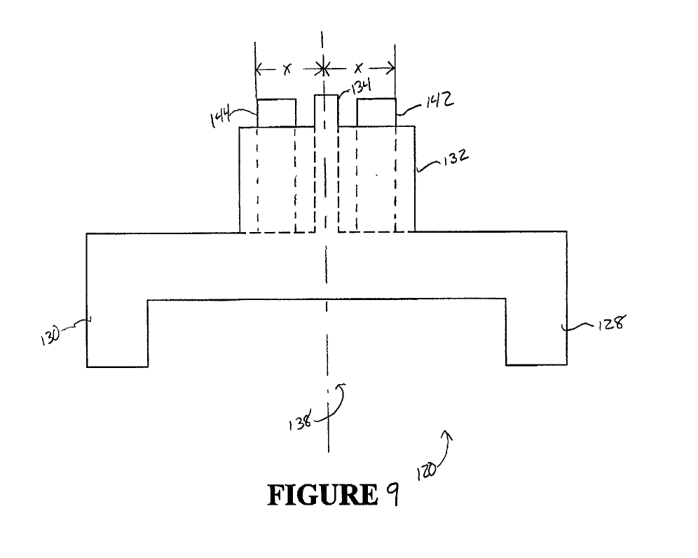

FIG. 9 is an end view of connector plug gap sealer 120 shown in FIG. 4. First section 122 (shown in FIG. 4) includes a vertical axis of symmetry 138 and a horizontal axis of symmetry 140. FIG. 9 depicts first leg 142 and second leg 144. First leg 142 and second leg 144 are positioned an equidistant X from vertical axis of symmetry 138. First section 122 (shown in FIG. 4) is a base section comprising first handle 128 and second handle 130 connected by a middle upper body 132. An upper body 134 is connected to middle upper body 132.

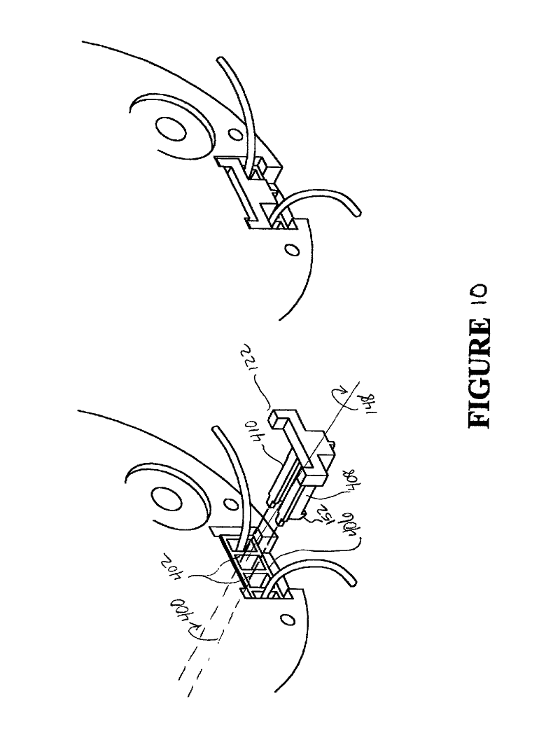

FIG. 10 is an exemplary embodiment of method steps 100 showing installation of connector plug gap sealer 120 shown in FIG. 4. The method includes holding plug sealer 120 from first section 122 (shown in FIG. 4) and aligning plug sealer 120 such that horizontal axis of symmetry 148 is substantially collinear to axis of symmetries 400 of cavities 402 of connector plug 406. Once aligned, the method further includes inserting plug sealer 120 into cavities 402 and applying sufficient pressure on side walls 408 and 410 to lock guiding section 152 and 304 (shown in FIG. 4) of plug sealer device 120 into a secured position within cavities 402 of connector plug 406.

While the invention has been described in terms of various specific embodiments, those skilled in the art will recognize that the invention can be practiced with modification within the spirit and scope of the claims.

1. A method for installing a connector plug gap sealer, said method comprising the steps of:
positioning a plug gap sealer;
inserting the plug gap sealer into a cavity of a connector plug; and
applying sufficient pressure to lock a guiding section of the plug gap sealer into a secured position within the cavity of the connector plug.

2. A method in accordance with claim 1 wherein said step of positioning a plug gap sealer further comprises the steps of:
holding the plug gap sealer; and
aligning the plug gap sealer such that an axis of symmetry of the plug gap sealer is substantially collinear to an axis of symmetry of the cavity of the connector plug.

3. A method in accordance with claim 1 wherein said step of positioning a plug gap sealer further comprises the step of utilizing an end section of a rectangular shape to position the plug gap sealer into the cavity.

4. A method in accordance with claim 1 wherein the plug gap sealer further includes a first section, a second section and a third section, the first, second, and third sections molded to form a single around a horizontal axis of symmetry.

5. A method in accordance with claim 1 wherein the plug gap sealer further includes a first section, a second section and a third section, the first, second, and third sections fabricated from a flexible, yet firm plastic material, and then assembled to form a single body.

6. A method in accordance with claim 1 wherein the second section further comprises a guiding section and a flat section, the guiding section having a beveled edge to guide the plug gap sealer into the cavity of the connector.

7. A method in accordance with claim 1 wherein said step of positioning the plug gap sealer further comprises the step of positioning a plurality of plug gap sealers within a plurality of connector plug gaps.

8. A method in accordance with claim 1 wherein said step of positioning the plug gap sealer further comprises the step of aligning the plug gap sealers within the walls of the cavity.

9. A method for installing a connector plug gap sealer with two axial positioning arms into cavities of a connector plug, said method comprising the steps of:
positioning a first and a second axial positioning arms, the first axial positioning arm includes a first leg and a first end, the first leg connected to the first end to form the first positioning arm, the second axial positioning arm includes a second leg and a second end, the second leg connected to the second end to form the second positioning arm;
inserting the first and second axial positioning arms of the plug gap sealer into a first and a second cavities of the connector plug; and
applying sufficient pressure on axial positioning arms to lock a plurality of guiding sections of the plug gap sealer into a secured position within the cavities of the connector plug.

10. A method in accordance with claim 9 wherein said step of inserting the plug gap sealer further comprises the step of inserting the first and the second axial positioning arms within a pair of adjacent cavities of the connector plug gap.

11. A method in accordance with claim 9 wherein said step of applying sufficient pressure further comprises the step of applying pressure on side walls of the first and second axial positioning arms and simultaneously moving the first and second axial positioning arms into the cavities.

12. A method in accordance with claim 11 wherein said step of applying sufficient pressure further comprises the step of applying pressure on the first and the second axial positioning arms side walls of the plug gap sealer and simultaneously moving the plug gap sealer into the cavity.

13. A connector plug gap sealer that fits smoothly within an internal cavity of a connector plug, said connector plug gap sealer includes a horizontal axis of symmetry and further comprising:
a first section including an upper body and a lower body;
a second section including a flat section and a guiding section, said second section extended from said first section around the horizontal axis of symmetry; and
a third section, said third section extended from the guiding section around the horizontal axis of symmetry said first, second and third sections configured into a single unitary piece to define the plug gap sealer having a flat bottom surface around the horizontal axis of symmetry of said plug gap sealer.

14. A connector plug gap sealer in accordance with claim 13 wherein said lower body has a trapezoid shape having a first flat bottom surface and a sloped top surface, said upper body rectangular in shape and connected to said lower body around said horizontal axis of symmetry.

15. A connector plug gap sealer in accordance with claim 14 wherein said upper body is square in shape.

16. A connector plug gap sealer in accordance with claim 13 wherein said guiding section of said second section configured to guide the connector plug gap sealer into a position within the connector plug cavity, said guiding section includes two substantially parallel surfaces perpendicular to the axis of symmetry and a substantially flat surface connected to a sloped surface, said top surface has a beveled angle where a first end height is greater than a second end height.

17. A connector plug gap sealer in accordance with claim 13 wherein said flat section of said second section is rectangular in shape having a length equal to a flat portion of the internal cavity of the connector, said flat section further includes a bottom surface substantially parallel to an upper surface and extending all the way to form the bottom surface of said second section.

18. A connector plug gap sealer in accordance with claim 17 wherein the bottom surface of said first section is substantially planar with the bottom surface of said second section.

19. A connector plug gap sealer with dual axial positioning arms that fit smoothly within two adjacent internal cavities of a connector plug, said connector plug gap sealer includes a horizontal axis of symmetry and further comprising:
a first section, said first section is a base section, further includes a first handle and a second handle connected by a middle upper body, an upper body connected to said middle upper body, said first section further includes a vertical axis of symmetry and a horizontal axis of symmetry;
a second section, said second section includes a first leg and a second leg, said first leg and said second leg positioned at an equidistant from said vertical axis of symmetry, said second section extended from said first action around the horizontal axis of symmetry;
a third section, said third section includes a first end and a second end, said first end and said second end positioned at an equidistant from said vertical axis of symmetry and away from said vertical axis by a pre-determined distance, said first end extending from said first leg to form a first axial positioning arm, and said second end extending from said second leg to form a second axial positioning arm; and
said first, second and third section configured into a single unitary piece to define the plug gap sealer having axial positioning arms with a flat bottom surface around the horizontal axis of symmetry of said plug gap sealer.

20. A connector plug gap sealer according to claim 19 wherein structural configurations of said first leg and said second leg are substantially identical.

21. A connector plug gap sealer according to claim 19 wherein said first leg extends from said first section around the horizontal axis of symmetry of said second section.

22. A connector plug gap sealer according to claim 19 wherein the horizontal axis of symmetry is substantially perpendicular to the vertical axis of symmetry of said first section.

23. A connector plug gap sealer according to claim 19 wherein said first and second legs further include a flat section and a guiding section, said flat section rectangular in shape having a length equal to a flat portion of an internal cavity of a connector, said guiding section includes two substantially parallel surfaces, said parallel surfaces perpendicular to the horizontal axis of symmetry.

24. A connector plug gap sealer according to claim 23 wherein structural configurations of said flat sections are substantially identical.

25. A connector plug gap sealer according to claim 24 wherein structural configurations of said guiding sections are substantially identical.

26. A connector plug gap sealer according to claim 25 wherein each of said guiding sections further includes a substantially flat top surface connected to a sloped surface, said flat top surface substantially parallel to a flat bottom surface, said flat top surface of said guiding section has a beveled angle where a first end height is greater than a second end height, said flat bottom surface also substantially parallel to an upper surface of said flat section, said flat bottom surface extends all the way to said middle upper body of said first section.

27. A connector plug gap sealer according to claim 26 wherein structural configurations of said first end and said second end are substantially identical.

28. A connector plug gap sealer according to claim 27 wherein said first and said second end each is rectangular in shape with an upper surface, a bottom surface, and two substantially parallel surfaces, said bottom surface substantially parallel to said upper surface and extending all the way to form a bottom surface of said plug gap sealer.

29. A connector plug gap sealer according to claim 28 wherein said bottom surface of first leg and said bottom surface of first end are substantially planar to form a single unitary bottom surface connecting said first leg and said first end of plug gap sealer.

30. A connector plug gap sealer according to claim 29 wherein said bottom surface of second leg and said bottom surface of second end are substantially planar to form a single unitary bottom surface connecting said second leg and said second end of plug gap sealer.

31. A plug gap sealer that fits smoothly within an internal cavity of a connector plug, said plug gap sealer further comprising a guiding section that guides the plug gap sealer into the cavity and a locking section that locks the plug gap sealer into a pre-determined position.

32. A plug gap sealer according to claim 31 wherein said guiding section and said locking section includes a common horizontal axis of symmetry.

33. A plug gap sealer that fits smoothly within an internal cavity of a connector plug, said plug gap sealer further comprising a first section, a second section, and a third section, said three sections configured into a single unitary piece to define the plug gap sealer having a flat bottom surface.

34. A plug gap sealer according to claim 33 wherein said first section includes an upper body and a lower body, said second section includes a flat section and a guiding section and extended from said first section around a horizontal axis of symmetry, and said third section extended from the guiding section around the horizontal axis of symmetry.

35. A plug gap sealer according to claim 34 wherein said flat bottom surface is formed around the horizontal axis of symmetry.
